(19) United States
(12) Patent Application Publication
(10) Pub. No.: US 2022/0291051 A1
(43) Pub. Date: Sep. 15, 2022

(54) CELLULAR CONNECTED WIRED TEMPERATURE SENSOR

(71) Applicant: Marc Freund, San Francisco, CA (US)

(72) Inventor: Marc Freund, San Francisco, CA (US)

(21) Appl. No.: 17/200,717

(22) Filed: Mar. 12, 2021

(51) Int. Cl. G01K 1/024; G01K 1/022

(52) U.S. Cl. CPC G01K 1/024; G01K 1/022; H04W 84/042

(57) ABSTRACT

A temperature sensing device (100), connected to a protected wire (105) which is integrated to the processing and cellular gateway device (115).

Currently, all existing art and products do not allow for temperature remote monitoring using cellular gateways in harsh or water environments due to the packaging of both the temperature sensor and sensing unit in one device. This significant change allows for temperature sensing in environments which cannot obtain radio or cellular connection or would simply be a medium which would destroy the components such as boiling water, harsh chemicals, etc.

This unique demonstration of using a cellular connected monitoring device along with the novel addition of a means for measurement of temperature or other sensor data which is not within the same space as the device allows for a multitude of new applications.

### FIELD OF INVENTION

THE PRESENT INVENTION RELATES TO REMOTELY MEASURING ENVIRONMENTAL CONDITIONS USING A WIRED SENSOR WITH CELLULAR CONNECTIVITY

### CROSS-REFERENCE TO RELATED APPLICATIONS

None.

### FEDERALLY SPONSORED RESEARCH

None.

### SEQUENCE LISTING

None.

### BACKGROUND

Monitoring the environmental conditions of a location of interest is a generally well understood and fully developed process, easily addressed by any number of solutions and tools. However, when that location of interest is one that is remote, without WiFi internet access or subject to power outages, that environmental monitoring process requires a unique approach with more specialized tools.

Currently U.S. Pat. No. 9,159,211B2 “Remote monitoring system with cellular gateway” provides a device to remotely monitor conditions via cellular signal. This invention has proven itself to be incredibly valuable for countless applications including recreational vehicle temperature monitoring for pet safety, the monitoring of cabins during extended unoccupied winter periods and for ensuring that IT server rooms remain within specified temperature limits and maintain power.

As useful as these devices have proven themselves to be, all current remote monitoring systems with cellular gateways on the market and described within any existing art, monitor environmental conditions such as temperature and humidity at the same physical location as the and cellular gateway device. These sensitive sensing components are often contained within the housing of the devices themselves.

The physical coloration of sensor element and cellular gateway becomes a severely limiting design feature for many applications such as the monitoring of harsh and corrosive fluids. The limitations of the sensitive electronic components of the cellular gateway then drive the capability of the system as a whole. Furthermore, previously envisioned extended sensing devices which, themselves, make use of cellular or RF signals have been shown to be unsuitable for direct measurements of such fluids due to incompatibilities with the fluid mediums of interest.

This invention allows for the cellular gateway device to be in an area conducive to wireless signal and in a non-harsh condition—while the temperature is able to be measured remotely via wired probe. This allows for a great expansion of applications including measuring temperatures of freezers, water or liquids which could be at extreme temperatures or extreme conditions (such as corrosive).

In current embodiments, these applications could never be satisfied due to needing to contain both the temperature sensor and sensing device within the same package—hence exposing the wireless capability to this extreme condition or lack of operational signal.

Current products as described in U.S. Pat. No. 9,159,211B2 would also not allow for extreme cold or hot temperatures, again due to sensitive components requiring remote communication and wireless data delivery via cellular connection. Additionally, there is often a need to monitor the environmental conditions of a space that is naturally limited in cellular reception such as a sealed freezer or incubator. In these cases, it is desired to measure conditions within the space but to locate the cellular gateway in an alternate area having optimal cellular signal strength.

### SUMMARY OF INVENTION

The present invention seeks to provide a solution to these problems by creating a cellular gateway and processing system which is separated by a flexible wire of a variable length attached to a measuring instrument.

### BASIC DESCRIPTION

In this embodiment of the invention, a sensor used for measurement of any number of physical conditions (temperature, pressure, humidity, lighting, vibration, etc.) is connected via wire capable of transmitting information from the sensor to the processing unit. With this flexible wire connected to the processing unit and coupled cellular gateway, the system is able to measure and report conditions at the sensor location along with additional measurements taking place at the cellular gateway. Some embodiments of these additional measurements could include power, humidity, barometric pressure, and ambient temperature.

### Most Important Preferred Aspects

In a preferred embodiment of the invention, the wire would be thin and flexible. The intent of the small gauge of the wire(s) is to be able to transfer information from the measurement probe sensor tip to the base unit or cellular gateway with the smallest amount of interference between the temperature measurement area and the cellular gateway and processing areas. The wire extending from the probe tip to the cellular gateway would preferably be able to bend or be manipulated in such a way that it could be routed through a small hole or gasket with minimal disruption to existing hardware. Additionally, the durability of the wire must be such that repeated adjustments and relocations will not cause any degradation in performance. A highly desirable use case for this invention is to remotely monitor freezer temperatures via cellular communications. Hence, the flexible wire connecting the preferred sensor of temperature to the cellular gateway and processing device must be at length necessary to provide the temperature sensor inside the freezer while the cellular gateway remains outside the freezer.

The wire extending from the sensor tip to the base unit may also contain easy connection/disconnect points such as a “male” end of a stereo jack (plug) which would plug into the complementary female jack located on the base of the cellular gateway and/or the tip of the temperature sensing device. This design feature allows user ease in the installation/removal and reconfiguration of systems, bypassing the need for labor intensive wire connection methods such as soldering. This capability is described in the preferred design however identical functionality could be achieved via more permanent wire connection methods including soldier, plug-in tips or other ways of connecting wire(s) to a control board and cellular gateway for measurement.

In a preferred embodiment of the invention, the temperature sensor is waterproof, having been sealed with an epoxy or other processes to allow for full immersion of the sensor into water or other liquid and also allowing for increased reliability and durability in its preferred use case, placed within a refrigerator or freezer. The sensor and wire apparatus may also contain clips, weights, suctions, snaps, velcro or other additions to aid in securing the sensor probe to a desired location within the preferred usage environment of a freezer or refrigerator. (see FIG. 3 or FIG. 4). This attachment method would allow the sensor to be secured to a wall or other feature within the freezer or refrigerator, thus extending its use by allowing the sensor to obtain more spatially accurate readings and avoiding any disruption that may be caused by the movement of articles within the freezer or refrigerator.

### BRIEF DESCRIPTION OF DRAWINGS

Some of the embodiments of the current invention are depicted as examples of invention the figures stated below. The figures are not meant to be a limiting:

FIG. 1 is a schematic diagram of the current invention of a cellular connected wired temperature probe

FIG. 2 is a schematic diagram of the cellular system within which the current invention operates.

FIG. 3 is a schematic diagram of the current invention that also includes additional detailed features including a display screen and audio warning capabilities.

FIG. 4 is a schematic diagram of the current invention that depicts the additional capability of multiple sensor probe wires connected to the cellular gateway.

FIG. 5 is a schematic diagram of the current invention that depicts the expanded capability that would be offered with the inclusion of a hub device to make use of multiple sensor probes.

### DETAILED DESCRIPTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

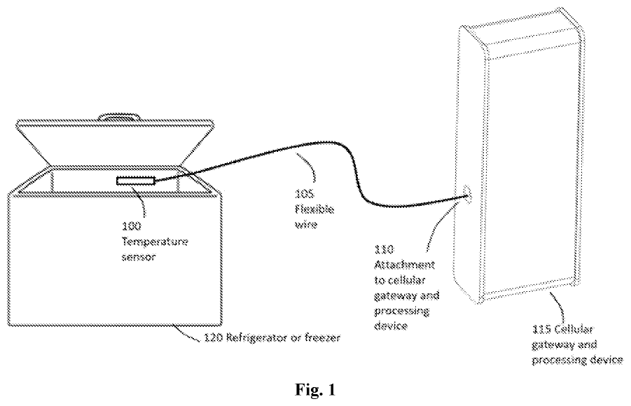

FIG. 1 illustrates a sensor (100), connected via protected flexible wire (105) to a cellular gateway and processing device (115) at an attachment point (110). Temperature or other measurements such as resistance, voltage, etc from waterproof/environmental resistant enclosure tip (100) would be sent via wire (105) to the cellular gateway and processing device (115) which would allow for the device to be outside of the unsuitable environment (120), thus increasing its reliability and cellular connectivity. This is a critical design feature as often in the preferred embodiment, a freezer would not be an optimal condition for the cellular gateway and processing device due to non ideal humidity, low temperatures, presence of water or poor cellular reception. The cellular gateway and processing device (115) is any device which can perform two main functions: use a cellular network via a cellular modem or other connection device to communicate the readings taken from the sensor and process the measured data. Processing is needed to convert measurement data into a format which is understandable by the user (for example degrees in Fahrenheit), however, the processing of this data can also occur outside of this device and only be sent via raw data with the cellular gateway. For example: resistances rather than temperature are likely collected, then transmitted via the cellular gateway which is then later converted by software code into degrees F. Hence, the process aspect of the device does not need to perform any core functions other than capturing sensor data, storing this data and transmitting the data via the cellular connection.

The cellular gateway/processing device (115) is a device which employs both a means of processing the information from the sensors (both the remote sensor as described in this invention) and additional sensors which are located within the same area, wireless sensors and additional information such as the presence of utility power. This processing device is then paired with a cellular gateway which is able to transmit information gathered from the sensors and transfer this via cellular network to a central processing server/computer to enable a user to remotely view their conditions. Additionally, the cellular gateway/processing device would employ a built-in battery system which would allow for transferring of information even if there is no ability for an external power source to be available, or the regular power source is lost during a power outage. This embodiment of the invention requires a cellular gateway as the preferred usage of monitoring freezers or refrigerators, the user would need to know if power is lost to the freezer and also need to monitor the temperature within the freezer or refrigerator regardless of power conditions. Using a cellular connection rather than will or another connection point allows for this capability.

Furthermore, the sensor (100) and flexible wire (105) would allow for replacement, changing or removal via a connection point (110). This iteration is optional, but ideal. This connection could be a quick disconnection of electrical wires such as audio jack, JST style, phone line style or other electrical coupler. Its intended use would be for ability for replacement or removal of the sensor (100) and flexible wire (105).

The flexible wire (105) is meant to be supplied at varied lengths depending on usage specifics and distance of the medium to be measured. For example, a shorter distance of a few feet or even a few inches may be optimal where the medium can be located close to the cellular gateway and processing device (115). Examples of this could be a refrigerator, freezer, aquarium, etc. However, a longer distance of wire might need to be employed if the medium of interest is far away or multiple areas are needing to be monitored. Such as multiple freezers, an outdoor pond, rooftop, etc.

Additionally, this flexible wire (105) could employ features to allow for an extended length to be added by use of quick connection plugs or even subtracted by the user to obtain any length needed. (similar to plugging multiple electrical extension cords together)

The wire (105) is ideally flexible and thin, however it must be durable enough to maintain physical integrity and to transfer the necessary information (data, voltage, resistance or other readings) accurately to the cellular gateway/processing device (115). Wire flexibility is a key feature as this invention relies on measurement of a space that is outside of the cellular gateway/processing device (115) either due to convenience (gateway placed inside to accommodate easy access while the measurements are being taken outside) or necessity (due to inability to receive cellular signal or needing to measure water). Often this would require passing through a gasket, doorway or small entry point which separates the area needing to be measured vs the area where the cellular gateway/processing device is contained. This wire (105) then could be diverted inside through the gasket with little amount of penetration issues or air leakage if measured medium is a freezer or refrigerator (120).

Furthermore, additions or modification to the wire shape, flexibility or additional features such as adhesives or tape are also embodiments of this invention to aid the user in facilitating the transfer of data from the medium which is being measured to the cellular gateway/processing device (115).

Additionally, this wire (105) can include quick connection points (110) to the cellular gateway/processing device (115). This may include a quick connection jack such as an audio male to female connection, molex connection or other plug styles. This is again a preferred embodiment since it allows for quick connection of the sensor (100) and wire (105) to the cellular gateway (115) while still allowing for replacement or changing of length or even type of sensor employed. This does not exclude an embodiment of a “hard wired” connection into the cellular gateway/processing device. This connection point can also be accomplished via other means of connection not shown or explained.

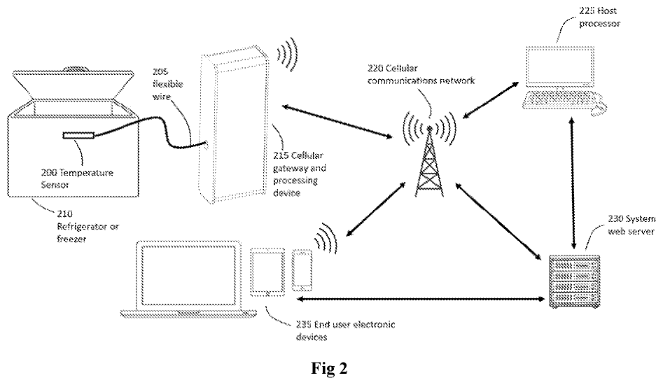

FIG. 2 illustrates the manner in which the current invention, the sensor (200), flexible wire (205) and cellular gateway and processing device (215) assembly fit into the broader system that is required in order to accomplish the ultimate desired goal of monitoring, data recording and notifying of issues that require user intervention. As is visually depicted in FIG. 2, the cellular gateway and processing device (215) communicates with a host processor (225) using existing cellular communication networks (220). That host processor stores user data on a system web server (230). Notifications and historical measured data can then be provided to end user electronic devices (235) in one of two ways; either via cellular communications networks (220) or directly over the Internet depending on the specific end user device (i.e. computer vs. cellular phone). Consumers, using their electronic devices (235) can also make adjustments to system settings or alert preferences. These adjustments make use of the same internet or cellular communications network (220) infrastructure. This setup allows a user to access their sensor information anywhere and set up alerts and trends to be analyzed.

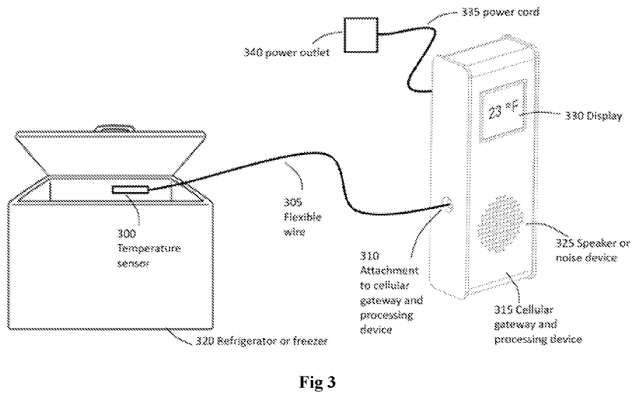

FIG. 3 illustrates additional features which could be included as features of the cellular gateway and processing device (315). This depicted embodiment includes these additional features which are novel to the cellular gateway and processing device and should be considered part of this claim. These features include a digital display (330), capable of showing a user temperature or other sensor data readings from the measured space, in this case refrigerator or freezer. This display (330) would be part of the cellular gateway and processing device (315). This display would be adaptable to show different readings in an easy to view format and indicate which reading is displayed. FIG. 3 also shows a potential speaker or noise device (325) which can audibly alert a user if the temperature or any other reading of the sensor (300) goes outside of the user specified desired ranges. For example: an alarm could be sounded if the temperature of the freezer goes beyond 15 degrees or if regular power is lost to the cellular gateway/processing device (315). This would help the user to be alerted if the user is in close proximity to the gateway/processing device (315).

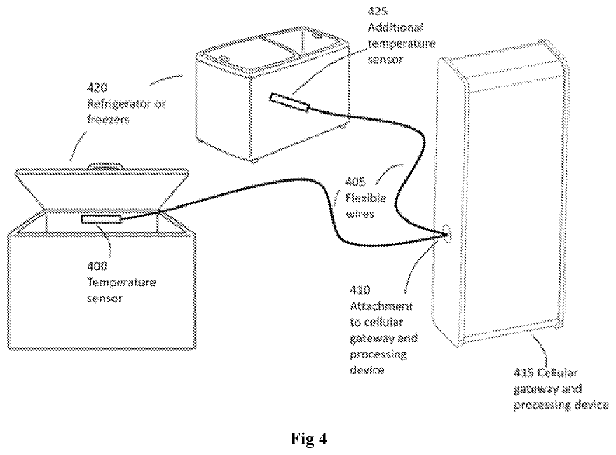

FIG. 4 shows the sensor (400) which could include multiple sensors (such as temperature and humidity). Additionally, the sensor in its preferred embodiment would be protected from the surroundings by a metallic tip and or epoxy to allow for immersion in water or other liquid. The protective tip made of metal, plastic or other material would help protect the sensor as the measurement of conditions in this invention are often beyond the operating abilities of the cellular gateway/processing device (due to being in water, extreme temperatures or inability to receive a cellular signal). Additionally depicted in FIG. 4 is the capability for multiple flexible wires (405) to be connected to the cellular gateway and processing device (415) and the attachment location (410). This additional capability would allow for expanded utilization, allowing users to run multiple flexible wires (405) to additional sensors (400) thereby monitoring additional freezers (420) or any other environment of interest.

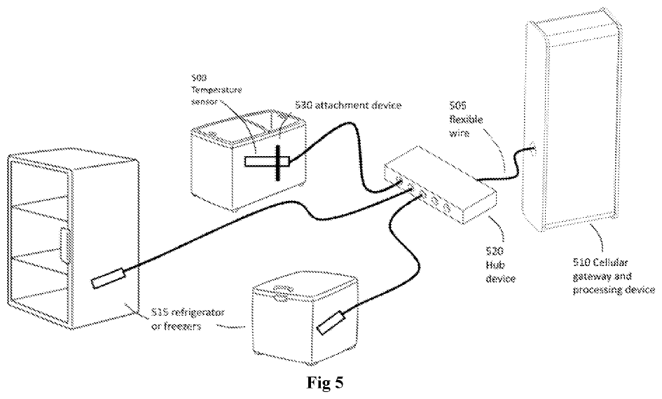

Illustrated in FIG. 5 are additional features which could be employed to either the sensor or the wire to aid in the deployment of the invention. FIG. 5 depicts an attachment device (530) that could take the form of weights, snaps, ties or suction cups along the length of the flexible wire (505) and or the sensor (500). For example: a weighted tip to the sensor could allow for the user to be sure to measure the bottom of the fish tank rather than potentially having the sensor floating. Likewise, in the inventions preferred embodiment, suction cups or ties could allow for the probe to be attached along the side of the refrigerator or freezer away from the food or staying out of the users general path of travel when operating the freezer.

Additionally, FIG. 5 depicts the use of a hub device (520) that would allow for and even greater expanded capability that is offered in the depiction in FIG. 4. The hub device (520) would connect to the cellular gateway and processing device (510) and allow for a number of flexible wire (505) attachments, allowing for significantly more sensors (500) to monitor numerous zones if interest such as freezers or refrigerators (515).

1. A method to monitor the temperature in a location that is physically removed from a cellular gateway and processing device via wired connection with an assembly consisting of: a temperature sensor, a flexible wire, and a base unit comprised of a cellular gateway and processing unit.

2. The method of claim 1 wherein the system further combines this temperature sensing probe with a unit that can use cellular networks to allow the user to receive alerts and trend data view information either remotely or on a physical display on the unit.

3. The method of claim 1 wherein the system further allows for measurement capabilities which can include humidity, lighting, vibration or other measurements. The assembly would then consist of a sensor or group of sensors(s) (temperature, humidity, lighting, power, pressure, etc.), flexible wire, and base unit comprised of a cellular gateway and processing unit.

4. The method of claim 1 wherein the system further allows for the use of multiple temperature or other sensors connected via flexible wires with the terminal end point connected either directly to the cellular gateway/processing device or to an intermediate location such as a wired hub. Hence, an expanded assembly would consist of:
i. Multiple ambient sensor(s) (temperature, humidity, lighting, etc.)
ii. Environmental sensors
iii. Flexible wires
iv. Hub or intermediate connection point
v. Cellular gateway/processing device

5. The method of claim 1 wherein the system further allows for the use of “quick” connection points between the assembly components to include jacks, snaps, plugs or any other means of connection between the assembly components.

6. The method of claim 1 wherein the system further allows for the use of extension wires to allow for a variable distance of flexible wire between components.

7. The method of claim 1 wherein the system further allows for specialty adaptors to provide optimal feedthrough into a freezer or refrigerator along the exterior gasket or another entry point to be used in conjunction with the flexible wire and connection point such that the system would then consist of:
i. Sensor(s)
ii. Flexible wire
iii. Specialty adaptor for entry into device
iv. Flexible wire
v. Cellular gateway/Processing device

8. The method of claim 1 wherein the system further allows for the use of a digital display on the cellular gateway/processing device to present sensor data locally.

9. The method of claim 1 wherein the system further allows for the use of an auditory alarm on the cellular gateway/processing device to alert the user to temperatures or other readings outside of the safe regions (in conjunction with or without digital display referenced in claim 8).

10. The method of claim 1 wherein the system further allows for the use of buffer solution that the temperature probe can be placed within to further stabilize temperature readings.
